(19) United States
(12) Patent Application Publication
(10) Pub. No.: US 2009/0325012 A1
(43) Pub. Date: Dec. 31, 2009

(54) ALKALINE FUEL CELL SYSTEM

(75) Inventor: Jiri Nor, Oakville (CA)

Correspondence Address: GOWAN INTELLECTUAL PROPERTY, 1075 NORTH SERVICE ROAD WEST, SUITE 203, OAKVILLE, ON, L6M-2G2, CA

(73) Assignee: ASTRIS ENERGI INC., Mississauga (CA)

(21) Appl. No.: 10/905,148

(22) Filed: Dec. 17, 2004

(51) Int. Cl. H01M 8/04

(52) U.S. Cl. 429/23

(57) ABSTRACT

An alkaline fuel cell system includes an alkaline fuel cell stack, a source of fuel gas, an oxidizer gas pump for oxidizer gas, an electrolyte tank, an electrolyte pump, an auxiliary electric storage device, and an electronic controller. The oxidizer gas pump is controlled by the electronic controller to deliver an oxidizer gas flow to the alkaline fuel cell stack which varies proportionately with the amount of electrical current drawn from the stack under any load conditions. At zero load, a minimal oxidizer gas flow is delivered to the fuel cell stack. The oxidizer gas pump may be a positive displacement pump such as a vane pump, a lobe pump, or a screw pump; or it may be a controlled blower. Also provided is a back pressure valve in the electrolyte flow circuit to maintain positive pressure in the electrolyte if the electrolyte is flowed through the fuel stack.

### FIELD OF THE INVENTION

This invention relates to alkaline fuel cells, and particularly to a system for controlling the operation of the alkaline fuel cell stack and its associated peripheral equipment in such a manner as to achieve high efficiency at most load conditions of the fuel cell, while at the same time assuring that there is less wear and tear on various components of the fuel cell stack including particularly the electrode structures thereof. The present invention provides for a novel air flow control and air flow recirculation system, and a novel electrolyte flow system whereby the physical height of a fuel cell structure may be reduced.

### BACKGROUND OF THE INVENTION

Alkaline fuel cells have been known, at least in rudimentary form, since shortly after the turn of the 20th century. Indeed, alkaline fuel cells have found at least limited success and acceptance because of their use by NASA, particularly since the Apollo missions. Alkaline fuel cells were also used by NASA for the space shuttle Orbiter vehicles. However, there has been much greater commercialization of Proton Electrode Membrane (PEM) fuel cells for a variety of reasons that need not be discussed in detail here.

On the other hand, the market is once again turning to alkaline fuel cells because of several specific advantages that they have over PEM fuel cells. Those advantages include the fact that alkaline fuel cells can be manufactured without having to rely on precious or noble metal electrodes; and that the electrolyte is alkaline and not acidic, which leads to better electrochemical performance and generally broader operating temperatures than those of PEM fuel cells.

A typical alkaline fuel cell system includes not only the alkaline fuel cell stack but a considerable amount of other onboard, associated peripheral equipment such as pumps, separators, and the like. The principal component, of course, is an alkaline fuel cell stack to which a fuel gas and an oxidizer gas are fed, and through which an alkaline electrolyte may be flowed. In a typical alkaline fuel cell in keeping with present invention, the fuel gas may be hydrogen, but it might also be such as methanol vapour gas. Typically, as well, the oxidizer gas is air, but it may also be oxygen or oxygen enriched air.

The electrolyte in the fuel cell stack may be static or immobilized, in which case no additional plumbing such as an electrolyte tank, and an electrolyte pump are required. Typically, however, the electrolyte is circulated through the alkaline fuel cell stack.

A typical fuel cell system will include a number of sensors which will operate in association with an electronic control system having an embedded microcomputer, whereby a variety of inputs and outputs concerning the operating parameters of the fuel cell system can be observed and controlled. They would include, of course, the input of fuel gas and oxidizer gas, and the flow of electrolyte when it is circulated through the fuel cell stack. Moreover, those parameters and others such as the operating temperature of the fuel cell stack may be contingent upon a number of parameters including the terminal voltage and particularly the current being drawn from the fuel cell stack, as well as the pressure of fuel gas and oxidizer gas, and electrolyte, flowing through the fuel cell stack, the level of electrolyte in the electrolyte tank, and so on.

However, it is to the control of the flow of oxidizer gas and electrolyte, when it is circulated through the fuel cell stack, through the alkaline fuel cell stack that the present invention is particularly directed. Accordingly, the present invention is directed towards an alkaline fuel cell system in which, for example, the flow of oxidizer gas to the alkaline fuel cell stack will vary proportionately with the amount of electrical current drawn from the alkaline fuel cell stack. Even at zero load condition, however, there will be some minimal flow of oxidizer gas through the fuel cell stack.

Another aspect of the present invention is to provide for controlled flow of oxidizer gas through the alkaline fuel cell stack whereby a portion of the oxidizer gas being exhausted from the alkaline fuel cell stack is returned to the fuel cell stack. This has the salutary effect of increasing the humidity and temperature of the oxidizer gas as it enters the fuel cell stack.

As will be noted hereafter, these features will reduce air flow through the fuel cell stack when it is not needed, thereby reducing wear and tear on a carbon dioxide scrubber; and particularly under partial load conditions, excess loss of water and excess cooling of the alkaline fuel cell stack can be prevented.

It should be noted that the structure of the alkaline fuel cell stack and particularly the electrodes thereof is beyond the scope of the present invention. Indeed, specific electrode structures are taught in a co-pending application assigned to the same assignee hereof, in the name of the same inventor. Neither is it the purpose of the present invention, nor this description, to provide a detailed discussion of a number of well-known peripheral components which are found in a typical fuel cell system, except as they may be controlled by the electronic control system, or except as they may be substituted by other similarly operating components, or ones which have a similar result as to their operation.

The inventor herein has quite surprisingly discovered that greater efficiency and less wear and tear on an alkaline fuel cell system can be achieved by the simple expedient of controlling the delivery of oxidizer gas through the alkaline fuel cell stack in a manner so that, except at very low load conditions, the amount of oxidizer gas delivered to the fuel cell stack will vary proportionately with the amount of current drawn therefrom. This is enhanced by the additional feature of recirculating a portion of the oxidizer gas exhausted from the alkaline fuel cell stack back into the alkaline fuel cell stack so as to lessen the humidity and temperature shock to the electrodes of the fuel cell stack which otherwise occurs as a consequence of delivery thereto of dry, cool ambient air.

The inventor herein has also discovered that by providing a back pressure valve in the electrolyte flow line for electrolyte being returned to the electrolyte tank, the physical height of the entire fuel cell package can be reduced while at the same time alleviating the problem of gases being ingested into the electrolyte stream through the porous electrodes of the alkaline liquid stack. This is achieved, as will be noted, by assuring that the pressure of the returned electrolyte at the exit from the stack is sufficiently above ambient pressure—typically in the range of 5 cm to 20 cm of water column.

### SUMMARY OF THE INVENTION

In accordance with one aspect of the present invention, there is provided an alkaline fuel cell system for delivering electrical energy to a load, wherein the fuel cell system includes an alkaline fuel cell stack, a source of fuel gas, an oxidizer gas pump for oxidizer gas, an electrolyte, an auxiliary electric storage device, and an electronic controller.

In keeping with the present invention, the oxidizer gas pump is controlled by the electronic controller to deliver an oxidizer gas flow to the alkaline fuel cell stack, which oxidizer gas flow varies proportionately with the amount of electrical current drawn from the alkaline fuel cell stack under any load conditions.

However, at zero load condition, there will be a minimal flow of oxidizer gas that is delivered to the alkaline fuel cell stack.

Typically, the electrolyte will be circulated through the fuel cell stack, in which case the fuel cell system will further comprise an electrolyte tank and an electrolyte pump for said electrolyte.

A feature of the alkaline fuel cell system of the present invention is that the electronic controller has an override capability to set oxidizer gas flow from the oxidizer gas pump to preselected values corresponding to specific load conditions on the alkaline fuel cell stack.

In general, in an alkaline fuel cell system according to the present invention, the fuel gas is hydrogen and the oxidizer gas is air.

A particular feature of an alkaline fuel cell system in keeping with the present invention is that the flow path of the oxidizer gas through the system includes an oxidizer gas recirculator installed at the oxidizer gas inlet to the alkaline fuel cell stack. Moreover, an input to the oxidizer gas recirculator includes a portion of the oxidizer gas being exhausted from the alkaline fuel cell stack.

Another feature of an alkaline fuel cell system in keeping with present invention is that the flow path of the electrolyte through the system includes a return column for gravitational return of the electrolyte to the electrolyte tank, wherein the top of the return column is substantially at the same height as the top of the alkaline fuel cell stack.

In this case, the top of the return column is closed with a vented filler cap which is open to the ambient atmosphere.

Also, the electrolyte is returned from the alkaline fuel cell stack to the return column near the top thereof through a controllable back pressure valve which is a spring loaded relief valve by which the pressure head of the returned electrolyte at the exit from the fuel cell stack is maintained above the ambient atmospheric pressure.

Typically, the pressure head of the returned electrolyte at the exit from the fuel cell stack is in the range of 5 cm to 20 cm of water column above the ambient atmospheric pressure.

Typically, the electrolyte is flowed through a heat exchanger which is arranged in series connection with the fuel cell stack.

In keeping with particular teachings of the present invention, the oxidizer gas pump may be a positive displacement pump chosen from the group consisting of a vane pump, a lobe pump and a screw pump, wherein the volumetric flow thereof varies with the driving speed of the pump.

Alternatively, the oxidizer gas pump may include an air blower, an air duct, and a flow sensor arranged to sense air flow in the air duct. In that case, the speed of the air blower is adjusted by the electronic controller in keeping with signals received from the flow sensor.

Still further, the alkaline fuel cell system may have an oxidizer gas pump which includes an air blower, an air duct, a flow restrictor in the air duct, and a differential pressure sensor arranged to sense differential pressure across the flow restrictor. In that case, as before, the speed of the air blower is adjusted by the electronic controller in keeping with signals received from the differential pressure sensor.

In such an arrangement as described immediately above, the flow restrictor may be chosen from the group consisting of an orifice, a nozzle, and a length of tubing or piping having a smaller diameter than the air duct.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is an overall general mechanical and electric schematic of an alkaline fuel cell system in keeping with present invention;

FIG. 2 is a mechanical schematic showing an alternative controllable flow arrangement for oxidizer gas;

FIG. 3 is a partial mechanical schematic showing the manner in which electrolyte may be returned to a return column; and

FIG. 4 shows an alternative manner in which electrolyte may be returned to a return column in a manner whereby the physical height of the return column is reduced.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

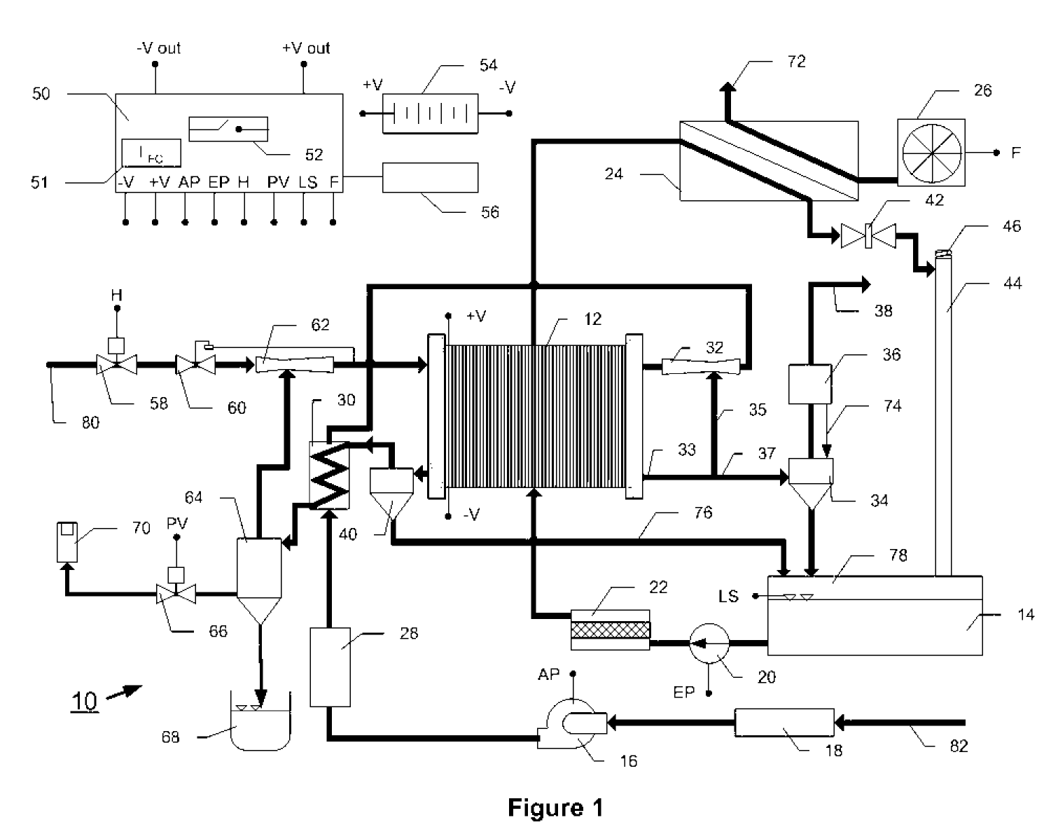

Turning first to FIG. 1, a brief overview of an entire alkaline fuel cell system in keeping with present invention is shown and indicated at 10. There are three independent fluid/gas regulated flow circuits, being that of the fuel gas—which is normally hydrogen gas—that of the oxidizer gas—which is normally air—and that of the alkaline electrolyte—which is normally an aqueous solution of potassium hydroxide. As will be seen hereafter, various components in each of the flow circuits act under the control of an electronic controller 50. To that end, it will be understood that electronic controller 50 has an embedded microprocessor and such other memory components, etc., as may be necessary and as are well known to those skilled in the art. The various electrical connections from those components to the electronic controller 50 will be understood with reference to the drawing and suggested terminals for those components and on the electronic controller 50. Of course, it will be understood that the entire arrangement as it is shown in FIG. 1, both as to the mechanical and electrical connections, is for purposes of illustration and discussion.

The fuel cell system comprises several major components to deliver electrical energy to a load (not shown). They include an alkaline fuel cell stack 12, an electrolyte tank 14, a source of fuel gas which enters the alkaline fuel cell system at 80, a source of oxidizer gas which enters the fuel cell system at 82 and is pumped into the system by oxidizer gas pump 16, an electrolyte pump 20, and an auxiliary electric storage device 54 whose purpose will be described hereafter.

Referring first to the fuel gas flow circuit, it will be seen that the fuel gas flows through a shut off valve 58, and thence through a pressure regulator 60 and a recirculator 62 to enter the alkaline fuel cell stack 12. It will be understood that the source of the fuel gas is pressurized, and that typically the pressure regulator 60 is a step-down regulator. Upon its exit from the alkaline fuel cell stack 12, the fuel gas flows through a cyclone separator 40 from which excess fluid electrolyte is removed from the gas flow and is returned via line 76 back to the electrolyte tank 14. Thereafter, the hydrogen gas flows through a condenser 30, and thence to another separator 64 within which water—which is the product of the electrochemical reaction which takes place within the alkaline fuel cell 12—is extracted and is sent to a water reservoir 68 from which it will be expelled from the alkaline fuel cell system. The remaining fuel gas is then returned to the recirculator 62, where it joins new fuel gas for delivery to the alkaline fuel cell stack 12, as previously described.

Occasionally there may be a requirement to purge the fuel gas flow circuit, such as when the fuel cell system is shut down for maintenance or other purposes, and for that reason a purge valve 66 and a hydrogen detector 70 are provided.

It will be seen from the above description of the fuel gas flow circuit that it is a closed circuit.

Turning now to the oxidizer gas flow circuit, the oxidizer gas, which is usually air, enters the alkaline fuel cell system at 82 and will flow through an intake filter 18 which may also serve the function as a silencer or muffler. Thereafter, the oxidizer gas flows through the oxidizer gas pump 16, which is responsible for providing the necessary impetus to the oxidizer gas to assure its flow through the alkaline fuel cell system, and from the oxidizer gas pump 16 the oxidizer gas flows through a carbon dioxide scrubber 28. Thereafter, the oxygen gas is directed to the condenser 30 through which effluent fuel gas is flowing, so that the flow of fuel gas through the condenser 30 is cooled and the water therein is thereby condensed, and at the same time the oxidizer gas is warmed up to some extent. The oxidizer gas is then fed to the alkaline fuel cell stack 12.

A particular feature the present invention is the provision of an oxidizer gas recirculator 32, whose purpose and structure are described hereafter.

Upon exit from the alkaline fuel cell stack 12, the oxidizer gas is directed to a cyclone separator 34 in which the bulk of the liquid, water and electrolyte that is carried by the oxidizer gas stream is removed, and thence to a demister 36. Any liquid which still remains in the oxidizer gas as it enters the demister 36 is returned to the separator 34 through line 74, and then it is returned back to the alkaline electrolyte tank 14. The spent oxidizer gas is exhausted from the alkaline fuel cell system at 38, where it is returned to the ambient atmosphere.

In the electrolyte flow system, it will be seen that that system is also a closed system, even though it is open to ambient as will be described hereafter. The alkaline electrolyte is pumped from the electrolyte tank 14 through the electrolyte pump 20, and thence through a filter 22 to the alkaline fuel cell stack 12. Upon exit from the fuel cell stack 12, the then warm electrolyte is fed to a heat exchanger or radiator 24, and thence to a return column 44 through which the liquid electrolyte is returned to the electrolyte tank 14.

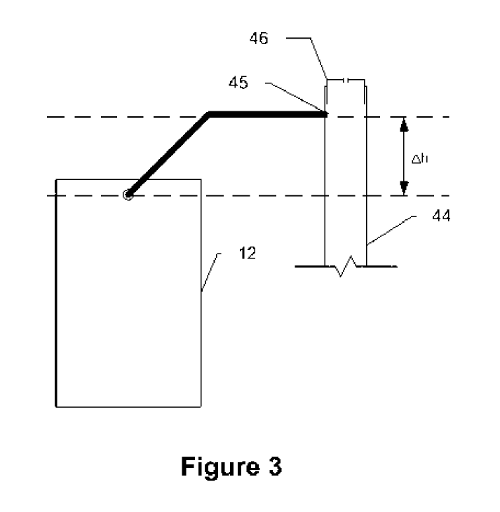

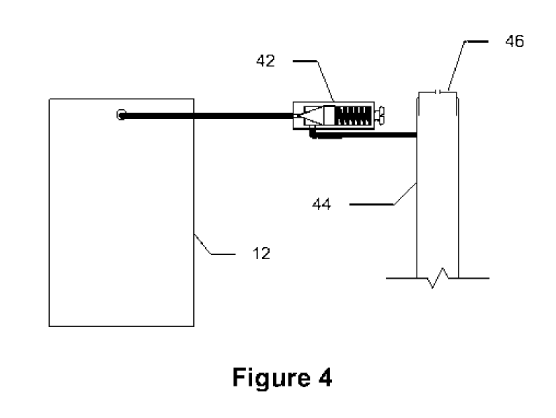

A particular feature of the present invention is the fact that the return column 44 may be closed with a vented filler cap 46; but more particularly, electrolyte will be flowed through a back pressure valve 42 so as to maintain a positive pressure with respect to the atmosphere for the electrolyte as it exits the alkaline fuel cell stack 12. This feature is particularly described hereafter, with reference to FIGS. 3 and 4.

The electrolyte is cooled in the heat exchanger 24. In FIG. 1, the heat exchanger is shown as being in series with the alkaline fuel cell stack at a point near the exit thereof; but it will be understood that the heat exchanger may be placed in any convenient location in series with the fuel cell stack, such as between the electrolyte tank 14 and the fuel cell stack 12. The amount of cooling may be controlled by flowing air through the heat exchanger 24 from a cooling fan 26, to exit from the heat exchanger 24 at 72. The operation of the cooling fan 26 is under the control of the electronic controller 50 at respective terminals “F”.

Likewise, the operation of such components as the shut off valve 58 and the purge valve 66 are also under the control of the electronic controller 50 at the respective terminals “H” and “PV”.

The alkaline fuel cell system of the present invention is provided with a front display panel 56 for purposes of operator control and system monitoring. An on/off switch 52 is provided whereby overall operation of the alkaline fuel cell system 10 may be initiated and terminated. One of the purposes of the auxiliary electric storage device 54, which is typically a battery or supercapacitor, is to provide an initial voltage and power to the system whereby the electrolyte pump 20 and the oxidizer gas pump 16 may be started, the shut off valve 58 may be opened, and other peripheral devices may be started and powered up, as necessary. Another purpose that the auxiliary electric storage device 54 may serve during operation of the alkaline fuel cell system is as a buffer battery in the event of widely varying loads and/or if the load temporarily increases its demand on the alkaline fuel cell system beyond its rated capacity. For that reason, and for reasons of monitoring the terminal voltage of the alkaline fuel cell stack 12, and to place it in parallel with the auxiliary electric storage device 54, connections are made between them and to the electronic controller 50 at terminals “+V” and “−V”.

Obviously, control of the electrolyte pump 20 by the electronic controller 50 is effected at terminals “EP”; and control of the oxidizer gas pump 16 by the electronic controller 50 is effected at terminals “AP”.

The power which is delivered to the load is effectively delivered from or under the control of the electronic controller 50, and is delivered at terminals “−V_{OUT}” and “+V_{OUT}”. During operation of the alkaline fuel cell system the current being drawn from the fuel cell stack 12 is continually monitored by a current monitor 51, which takes instantaneous readings of the current “I_{FC}” from the alkaline fuel cell stack 12 to the load and/or to the auxiliary storage device 54.

The level of the electrolyte within the electrolyte tank 14 is monitored by a level sensor 78 which has upper and lower limits, and which communicates with the electronic controller 50 through terminals “LS”.

Operation of the alkaline fuel cell system, and particularly its efficient operation, is particularly an artifact of a specific feature of the present invention, namely that the oxidizer gas pump 16 is controlled by the electronic controller 50 in such a manner that the flow of oxidizer gas to the alkaline fuel cell stack 12 will vary proportionately with the amount of electrical current drawn from the alkaline fuel cell stack 12 under any load conditions except that when no current is being drawn form the alkaline fuel cell stack 12, the oxidizer gas flow will be maintained at a minimal but positive value which is but a small fraction of the maximum oxidizer gas flow. In other words, at no load, there will be relatively low oxidizer gas flow through the alkaline fuel cell stack 12, and at higher loads the flow of oxidizer fuel will increase commensurately. This feature has been hitherto unknown.

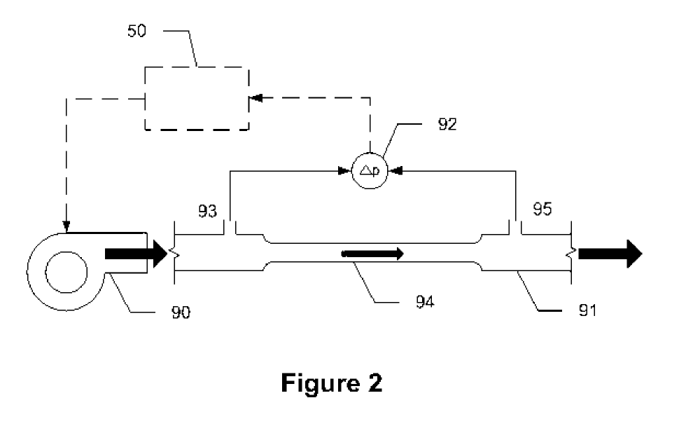

The oxidizer gas pump 16 may be a volumetric pump or positive displacement pump such as a vane pump, a lobe pump or a screw pump, where the oxidizer gas through flow varies directly with the speed at which such volumetric pump is driven. Typically, a volumetric pump will deliver a controllable air flow which may be unaffected over wide limits by changes of the pressure head. Another option whereby flow of oxidizer gas will vary proportionately with the amount of electrical current drawn from the alkaline fuel cell stack 12 is the use of an air blower and a flow sensor arranged with a feedback loop controller by which the air blower may be controlled to achieve the same effect. This is described hereafter with respect to FIG. 2.

In a typical alkaline fuel cell system as a shown in FIG. 1, the typical pressure head that the oxidizer gas pump 16 has to overcome is only in the order of 10 cm to 25 cm of water column. Variations in that pressure head which may be due to variations in temperature and humidity of the ambient from which air, the typical oxidizer gas, is drawn, are only a fraction of that pressure head, and therefore will cause only inconsequential variations in the rate of flow of the oxidizer gas.

It is the purpose of the present invention to provide that the air flow Q_{AIR} is delivered, with a sufficient safety factor, but is otherwise directly proportional to the applied voltage which may be delivered to the oxidizer gas pump 16 when it is a direct drive, volumetric, positive displacement pump where the output will, indeed, vary with the applied voltage. This gives rise to the following relationship:

Q_{AIR}=C·V_{AIR}

In operation, the fuel cell system 10 is a load following device. That means that usage of fuel gas and oxidizer gas is proportional to the current which is drawn from the alkaline fuel cell stack 12. That means that the maximum amount of fuel gas and oxidizer gas are consumed in the alkaline fuel cell stack 12 when maximum current is drawn therefrom. However, when there is no current being drawn from the fuel cell stack 12, usage of fuel gas and oxidizer gas will tend towards zero but will settle at a small value above zero due to parasitic losses which occur in the system, primarily as a consequence of parasitic currents which occur in the electrolyte manifolds within the alkaline fuel cell stack 12.

For that purpose, the current sensor 51 is provided which sends a signal I_{FC} to the electronic controller 50, so that the electronic controller 50 will continually and instantaneously resolve the equation:

V_{AIR}=A+B·I_{FC}

In the above equation, the coefficients A and B are programmed into the memory of the electronic controller 50, and are selected so that value A determines the minimal amount of air flow when no current is being drawn from the alkaline fuel cell stack 12, and value B determines the stoichiometric excess of the air—which is typically 2 to 2.5 times the required stoichiometric value. Thus, the voltage V_{AIR} is continually set to drive the oxidizer gas pump 16 when it is a volumetric, positive displacement pump.

There may be occasions when it is required to set the operating voltage V_{AIR} of the volumetric oxidizer gas pump 16 to preselected values such as V_{HIGH} or V_{MAX}. In that case, the preselected values will correspond to specific load conditions on the alkaline fuel cell stack and may, at appropriate times, be set for such purposes as product water management. Typically, the electronic control system 50 may set the control voltage for a volumetric oxidizer gas pump 16 to V_{HIGH} so as to remove the product water at higher rate through increased evaporation; or to set the operating control voltage of the volumetric oxidizer gas pump 16 to V_{MAX} so as to assist recovery from a temporary overload of the alkaline fuel cell stack 12.

The precise details of any volumetric or positive displacement pump that may be used as the oxidizer gas pump 16 are beyond the scope of the present invention. As noted, a typical positive displacement pump that may be used may be a vane pump, a lobe pump or a screw pump. It can be noted that when a lobe pump is employed, the delivery of oxidizer gas will be a pulsating air flow, whereas a screw pump will deliver a nearly continuous air flow. Lobe pumps have a higher aerodynamic noise than screw pumps, so that if the latter is employed it may be possible to eliminate the use of an intake silencer 18, although a filter may still be required to be employed.

An alternative arrangement for delivery of a controllable air flow which varies with the amount of current drawn from the alkaline fuel cell stack 12 is shown in FIG. 2. Here, an air blower 90 is employed; but it is noted that an air blower is not a positive displacement device. Indeed, an air blower may have a pronounced variation of its air flow depending on its pressure head. Thus, it is not possible to rely on the relationship between the applied voltage to the air blower 90 and the resulting air flow, as it may be when positive displacement devices are employed as described above.

In this case, a flow sensor 92 is employed so as to measure the actual air flow. Here, the electronic controller 50 is situated in a feedback loop from the flow sensor 92 to the air blower 90. The value of the actual flow of oxidizer gas is compared by the electronic controller 50 with the value of the desired flow of oxidizer gas, and the speed of the air blower 90 is adjusted accordingly. Flow sensors employing various physical principles may be employed, and in the example of FIG. 2, flow sensing through the oxidizer gas conduit 91 is accomplished by placing a differential pressure sensor 92 across a flow restrictor 94, and sensing the differential pressure from points 93 to 95. It will be understood that the flow restrictor 94 may be such as an orifice, a nozzle, or length of tubing having a smaller diameter than the air duct 91.

The advantage of using variable flow of the oxidizer gas is significant, particularly when compared with prior art devices which typically have employed an uncontrolled air blower. Those advantages include the fact that by using only the amount of oxidizer gas that is necessary at any instant in time, wear and tear of the carbon dioxide scrubber 28, and indeed of the internal components of the alkaline fuel cell stack 12, are lessened. Moreover, if the alkaline fuel cell system as described herein is operating at partial load conditions, below the maximum rated load capacity of the alkaline fuel cell stack 12, then use of only the requisite amount of oxidizer gas flowing through the alkaline fuel cell stack 12 will preclude excess loss of water and excess cooling of the stack, thereby making it much easier for the stack to reach its optimal operating temperature in use.

Returning now to FIG. 1, reference is made to the oxidizer gas recirculator 32, and its function within the oxidizer gas flow circuit. Here, it is seen that a portion of the oxidizer gas which exits the alkaline fuel cell stack 12 at 33 is returned to the recirculator 32 via line 35, while the remainder of the exiting oxidizer gas flows via line 37 to the separator 34. It will be understood that the oxidizer gas that exits the alkaline fuel cell stack 12 at 33 is warm and humid.

It may be possible to recirculate a portion of that oxidizer gas as it exits the alkaline fuel cell stack 12 by way of a pump, but the present invention provides for the use of an injector functioning as a recirculator 32. The precise design of the recirculator 32 is beyond the scope of the present invention; but it will be understood that the recirculator 32 effects a small pressure differential at the end of line 35 where it enters the recirculator 32, in the order of several centimeters of water column, sufficient to draw a desired amount of the exiting oxidizer gas from the alkaline fuel cell stack 12 to the recirculator 32. This is particularly effective in a range of from 20% to 120% of rated power output from the alkaline fuel cell system.

There are several reasons by which the recirculation of a portion of the exiting oxidizer gas from the alkaline fuel cell stack 12 back through the recirculator 12 increases the operating efficiency and improves the operating conditions of the alkaline fuel cell stack 12. As previously noted, one advantage of oxidizer gas recirculation is that the shock to the electrode structures of the alkaline fuel cell stack 12 from cold dry oxidizer gas is reduced, thereby reducing wear and tear of the electrodes. Indeed, it has been noted that the beneficial effect of oxidizer gas recirculation is significant with respect to the oxygen or air cathodes of the alkaline fuel cell stack 12, where much of the water evaporation within the fuel cell stack will take place while at the same time water is being carried from the cathode to the anode. At the anode, where the reaction water is produced, the benefit of recirculation of oxidizer gas is somewhat less; but advantage is taken of the fact that condensation of water from the fuel gas stream is accomplished, and recirculation is helpful in raising the dew point of the fuel gas to the range of ambient temperature as compared with the dry condition of the compressed fuel gas as it is first delivered to the alkaline to cell stack.

In the following discussion, the recirculation factor for determining the amount of oxidizer gas recirculation is defined as the ratio of recirculated oxidizer gas flow to the amount of intake oxidizer gas flow. At an air recirculation factor of 1, when the amount of recirculated oxidizer gas equals the amount of intake oxidizer gas the temperature gradient at the inlet to the alkaline fuel cell stack 12 may be reduced approximately to half. The humidity effect is much more pronounced, because the moisture content of air increases nearly exponentially as the temperature increases.

An example of the benefit of oxidizer gas recirculation now follows: the assumption is made that the oxidizer gas is air, and that the ambient air at the intake 82 to the fuel cell system has the dew point of 15° C. This translates into a moisture content of 12.8 g/m³. If the air gets warmed up in the alkaline fuel cell stack 12 to an exit temperature of 65° C., and the air is saturated with moisture, then its moisture content will be 161 g/m³. If this exit air is then mixed with fresh intake air in equal quantities, giving a recirculation factor of 1, then the resulting moisture content which will returned to the alkaline fuel cell stack inlet will be (161+12.8)/2, or 86.9 g/m³. This, in turn, corresponds to dew point of about 51° C.

If the ambient air temperature were to be 25° C., then the resulting temperature upon mixing equal quantities of dry air at temperatures of 25° C. and 65° C., respectively, will be (65+25)/2, or 45° C. As the dew point of the mixture exceeds this temperature, there may be a slight oversaturation of the air being input to the alkaline fuel cell stack 12, in this example, as a result of mixing moist and dry air, and this will lead to a formation of mist accordingly. Moreover, the heat of condensation will further increase the temperature of the mixture of fresh air and recirculated air, giving rise to very favorable oxidizer gas conditions at the input to the alkaline fuel cell stack 12.

If the stoichiometric quantity of air being delivered to the alkaline fuel cell stack is two times what is required, without recirculation, then air will enter the alkaline fuel cell stack having 21% oxygen and will leave the alkaline fuel cell system at 38 with the oxygen being half depleted, in other words with about 10.5% oxygen remaining. With recirculation in keeping with the present invention, the same amount of air will pass through the alkaline fuel cell stack, with the same exit content of about 10.5% oxygen. However, the oxygen content of the incoming air at the entrance to the alkaline fuel cell stack 12, as it leaves the recirculator 32, results from the mixing of the fresh and recirculated air in equal quantities, and is therefore (21+10.5)/2, or 15.75%. Taking averages throughout the alkaline fuel cell stack 12, the average oxygen concentration in air without recirculation becomes (21+10.5)/2, or 15.75%; and in the case of recirculation, it becomes (15.75+10.5)/2, or 13.12%. The difference is approximately 2.5% in average oxygen content.

However, that small difference in average oxygen content is of minor consequence when compared with the favorable temperature and moisture conditions at the oxidizer gas inlet to the alkaline fuel cell stack 12.

Finally, turning to FIGS. 3 and 4, discussion of the control of electrolyte being returned to the electrolyte tank 14, and the advantages of a provision such as that shown in FIG. 4, is now given. It will be understood that it is desirable during operation of the alkaline fuel cell system in keeping with the present invention for there to be a positive pressure maintained in the electrolyte as it flows through the alkaline fuel cell stack 12. By maintaining such positive pressure, the problem of ingesting gases into the electrolyte stream through the porous electrodes is alleviated, if not precluded. One way of maintaining that positive pressure is shown in FIG. 3, where electrolyte is shown exiting the fuel cell stack 12 and being directed to the return column 44 at a height of Δh above the exit point from the alkaline fuel cell stack 12. It should be noted that typically electrolyte flow in an alkaline fuel cell stack is from bottom to top. By arranging the point 45 in the return column 44 as shown in FIG. 3, and providing for a vented filler cap 46, it is clear that a positive pressure at the top of the alkaline fuel cell stack 12 which is equal to the height of the column of electrolyte Ah, will be maintained. Typically that pressure is in the range of 5 to 20 cm of water column. Of course, the vented filler cap 46 also serves the purpose of permitting filling the electrolyte tank 14 with electrolyte, when needed. Typically, as noted, the vent in the filler cap 46 is the only place where the electrolyte circuit is open to the atmosphere.

What is shown in FIG. 4 is a novel arrangement whereby the height of the return column 44 may be kept at about the same height as the height of the fuel cell stack 12, thereby permitting easier packaging of the entire alkaline fuel cell system. In this case, a controllable back pressure valve which is a spring loaded relief valve 42 is provided. The precise details of the back pressure valve 42 are beyond the scope of the present invention, except that it will be understood that it is typically a spring loaded relief valve having fine control over the spring pressure. This permits the maintenance of a positive pressure having the desired value, in the electrolyte, without the necessity for the increased height of the return column 44.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially the same height is intended to mean of the same height, nearly the same height, and/or exhibiting characteristics associated with being of a particular elevation above a reference elevation.

1. An alkaline fuel cell system for delivering electrical energy to a load, wherein said fuel cell system includes an alkaline fuel cell stack, a source of fuel gas, an oxidizer gas pump for oxidizer gas, an electrolyte, an auxiliary electric storage device, and an electronic controller;
wherein said oxidizer gas pump is controlled by said electronic controller to deliver an oxidizer gas flow in a first gas flow open circuit to said alkaline fuel cell stack which flow varies proportionately with the amount of electrical current drawn therefrom under any load conditions other than at zero load conditions; and,
further comprising an electrolyte tank and an electrolyte pump for recirculating said electrolyte;
wherein the flow path of said electrolyte is through a second liquid flow closed loop circuit within said system, and said second liquid flow closed loop circuit includes a return column which is open to the ambient atmosphere for gravitational return of said electrolyte to said electrolyte tank,
wherein the top of said return column is substantially at the same height as the top of said alkaline fuel cell stack and is closed with a vented filler cap;
wherein said electrolyte is returned from said alkaline fuel cell stack to said return column near the top thereof through a controllable back pressure valve which is a spring loaded relief valve by which the pressure head at the top of the fuel cell stack of the returned electrolyte is maintained above the ambient atmospheric pressure and so as to provide a positive pressure in the electrolyte as it flows through the alkaline fuel cell, during operation;
wherein the flow of fuel gas into said system is through a gas flow regulator and a gas flow recirculator, and is set to deliver a minimal flow of fuel at zero load conditions;
wherein unexpended fuel gas is returned from said alkaline fuel cell stack to said gas flow recirculator through a third closed loop gas flow circuit; and
wherein at zero load condition, said oxidizer gas pump and said gas flow regulator are controlled by said electronic controller to deliver a minimal flow of oxidizer gas and fuel to said alkaline fuel cell stack.

2. (canceled)

3. (canceled)

4. The alkaline fuel cell system of claim 14, wherein said electronic controller has an override capability to set oxidizer gas flow from said oxidizer gas pump to preselected values corresponding to specific load conditions on said alkaline fuel cell stack.

5. The alkaline fuel cell system of claim 14, wherein said fuel gas is hydrogen and said oxidizer gas is air.

6. The alkaline fuel cell system of claim 14, wherein the flow path of said oxidizer gas through said system includes an oxidizer gas recirculator installed at the oxidizer gas inlet to said alkaline fuel cell stack, and wherein an input to said oxidizer gas recirculator includes a portion of the oxidizer gas being exhausted from said alkaline fuel cell stack.

7. (canceled)

8. The alkaline fuel cell system of claim 14, wherein said pressure head at the top of the fuel cell stack of the returned electrolyte is in the range of 5 cm to 20 cm of water column above the ambient atmospheric pressure.

9. The alkaline fuel cell system of claim 14, wherein said electrolyte is flowed through a heat exchanger which is arranged in series connection with said fuel cell stack.

10. The alkaline fuel cell system of claim 14, wherein said oxidizer gas pump is a positive displacement pump chosen from the group consisting of a lobe pump, a vane pump, and a screw pump, wherein the volumetric flow thereof varies with the driving speed of said pump.

11. The alkaline fuel cell system of claim 14 wherein said oxidizer gas pump includes an air blower, an air duct, and a flow sensor in said air duct;
whereby the speed of said air blower is adjusted by said electronic controller in keeping with signals received from said flow sensor.

12. The alkaline fuel cell system of claim 14, wherein said oxidizer gas pump includes an air blower, an air duct, a flow restrictor in said air duct, and a differential pressure sensor arranged to sense differential pressure across said flow restrictor;
whereby the speed of said air blower is adjusted by said electronic controller in keeping with signals received from said differential pressure sensor.

13. The alkaline fuel cell system of claim 12, wherein said flow restrictor is chosen from the group consisting of an orifice, a nozzle, a length of piping having a smaller diameter than said air duct, and a length of tubing having a smaller diameter than said air duct.

14. An alkaline fuel cell system for delivering electrical energy to a load, wherein said fuel cell system includes an alkaline fuel cell stack, a source of fuel gas, a source of oxidizer gas; an oxidizer gas pump for said oxidizer gas in a first gas flow open circuit, an electrolyte, an auxiliary electric storage device, and an electronic controller;
wherein said oxidizer gas pump is controlled by said electronic controller to deliver an oxidizer gas flow in said first gas flow open circuit to said alkaline fuel cell stack which flow varies proportionately with the amount of electrical current drawn therefrom under any load conditions other than at zero load condition; and
further comprising an electrolyte tank and an electrolyte pump for recirculating said electrolyte;
wherein the flow path of said electrolyte is through a second liquid flow closed loop circuit within said system, and said second liquid flow closed loop circuit within said system includes a return column which is open to the ambient atmosphere for gravitational return of said electrolyte to said electrolyte tank and wherein said electrolyte is under a positive pressure as it flows through the alkaline fuel cell, during operation;
wherein the flow of fuel gas into said system is through a gas flow regulator and a gas flow recirculator, and is set to deliver a minimal flow of fuel at zero load conditions;
wherein unexpended fuel gas is returned from said alkaline fuel cell stack to said gas flow recirculator through a third closed loop gas flow circuit; and
wherein at zero load condition, said oxidizer gas pump and said gas flow regulator are controlled by said electronic controller to deliver a minimal flow of oxidizer gas and fuel to said alkaline fuel cell stack.

15. An alkaline fuel cell system as claimed in claim 14 wherein the top of said return column is substantially at the same height as the top of said alkaline fuel cell stack.

16. An alkaline fuel cell system as claimed in claim 14 wherein said electrolyte is returned from said fuel cell stack to said return column near the top thereof through a controllable back pressure valve which is a spring loaded relief valve by which the pressure head at the top of the fuel cell stack of the returned electrolyte is maintained above the ambient atmospheric pressure.
